(19) United States
(12) Patent Application Publication
(10) Pub. No.: US 2009/0011385 A1
(43) Pub. Date: Jan. 8, 2009

(54) NON-INVASIVE METHOD FOR TREATING PERIODONTAL DISEASE

(75) Inventors: Steven D. Jensen, South Jordan, UT (US); Densen Cao, Sandy, UT (US)

Correspondence Address: GEOFFREY E. DOBBIN, PATENT ATTORNEY, 4278 SOUTH 6220 WEST, WEST VALLEY CITY, UT, 84128-6501, US

(73) Assignee: CAO Group, Inc., West Jordan, UT (US)

(21) Appl. No.: 12/141,055

(22) Filed: Jun. 17, 2008

Related U.S. Application Data
(63) Continuation-in-part of application No. 11/961,557, filed on Dec. 20, 2007.
Application No. 11/961,557 is a continuation of application No. 10/913,702, filed on Aug. 6, 2004, now abandoned.
(60) Provisional application No. 61/050,472, filed on May 5, 2008.

(51) Int. Cl. A61C 1/07

(52) U.S. Cl. 433/215; 433/119

(57) ABSTRACT

The present invention is a method of non-invasive treatment of periodontal disease using ultrasonic waves. The treatment involves placing a tray, covering a metal fork, over the arch intended to be treated. The tray holds the metal fork to the teeth and gingival surface. The metal fork is connected to at least one ultrasonic transducer, which is in turn connected to a control unit that controls the delivery of ultrasonic energy. Both upper and lower arches can be treated simultaneously. The tray(s) may be filled with a therapeutic gel or the patient's own saliva maybe permitted to fill the tray and serve as a conductive gel. The ultrasonic waves, both alone or with a therapeutic gel, and heal the diseased tissue without surgery or curettage. Treatment may be repeated as needed or it may be used as a preventative measure with lesser treatment time.

### CROSS-REFERENCES TO RELATED APPLICATIONS

This Application claims priority as a Continuation-in-Part Application of prior filed U.S. application Ser. No. 11/961,557, filed Dec. 20, 2007, which is in turn a Continuation Application of Prior filed U.S. application Ser. No. 10/913,702, filed Aug. 6, 2004, now abandoned. This Application is also a non-provisional perfection of prior filed U.S. Provisional Application 61/050,742, filed May, 5, 2008. All of these Applications are incorporated herein by reference in their entirety.

### FIELD OF THE INVENTION

The present invention relates to the field of oral tissue treatments and more particularly relates to a non-invasive method for treating periodontal disease utilizing ultrasonic waves and/or a combination of ultrasonic waves along with treatment gels to reverse disease progression.

### BACKGROUND OF THE INVENTION

The use of ultrasonic waves in various healing techniques is known, including use in wound healing. Ultrasonic technology has also been used in dentistry for the removal of plaque. Ultrasonic devices in dentistry fall into two categories: toothbrushes and scalers. Ultrasonic toothbrushes use ultrasonic waves along with toothpaste to help in the loosening of plaque and debris from on and between teeth and along the gingival margin. Ultrasonic scalers utilize an ultrasonic transducer to generate ultrasonic energy, which is conducted to a narrow tip. The said tip works along with a liquid solution, either water or a mixed chemical, to achieve a cavitation effect and remove plaque on the teeth or the sub-gingival area so as to maintain teeth health. In both cases, the tool itself utilizes ultrasonic energy along with a working media to physically remove debris from the teeth and gingiva and require contact with the debris to move it. Ultrasonic waves are also known to have anti-bacterial qualities (see, U.S. Pat. No. 5,611,993)

Periodontal disease results from the formation of bacteria, growing on the surfaces and roots of the teeth. There are several diseases, like heart disease and diabetes, found to be related to the same bacteria which result in periodontal disease. Therefore, the treatment of periodontal disease is very critical to human health. Currently there are few effective treatments of periodontal disease. The existing treatments of periodontal disease employee either an anti-microbial injection into a periodontal pocket or physical/chemical therapy. In the anti-microbial injection method, the plaque on any surface or root is first removed, and then an anti-microbial is injected into the periodontal pocket to kill the bacteria remaining in the sub-gingival area. This method has not been proved fully effective. In the physical therapeutic method, scaling and curettage procedures are used. Scaling is the removal of calculus and debris from around and under the gingival margin. Curettage involves the scraping and removal of diseased tissue from periodontal pockets formed in the progression of periodontal disease. While scaling is not particularly invasive, curettage is extremely invasive, requires anesthetic and results in excessive bleeding. After curettage is performed, the wounded periodontal tissue heals, generally higher on the tooth than before; however, several curettage treatments are often required to fully eliminate the periodontal pocket. In short, the physical treatment method is to repeatedly wound the tissue and cause the body's natural healing to rebuild it in a manner that eventually restores it. Both methods are the best available to patients up to date. Therefore, what is needed is an effective and convenient method to treat periodontal disease.

The present invention is a non-invasive and in situ whole arch periodontal treatment utilizing ultrasonic waves or combination of ultrasonic energy along with treatment gels. The present invention represents a departure from the prior art in that the method of the present invention allows for stimulation and healing of the gingival tissue using ultrasonic waves without the damaging physical contact of a tool or painful injections.

### SUMMARY OF THE INVENTION

In view of the foregoing disadvantages inherent in the known types of periodontal treatment, this invention provides a non-invasive and whole arch periodontal treatment. As such, the present invention's general purpose is to provide a new and improved periodontal treatment method that will promote the healing of periodontal tissues without the need for injection of medicine, or invasive, painful and wounding curettage. Not only is the invented method non-invasive, but it is simple enough to be used as a preventative measure in regular dental checkups.

To accomplish these objectives, the method comprises the steps of placing a tray on an metal fork connected to an ultrasonic transducer, and placing the tray into the mouth of a patient, covering either or both of the upper and lower arches simultaneously or an individual upper arch or an lower arch, respectively. A conductive medium may be added to the tray to enhance the treatment. The patient's saliva may serve as the medium, or medicines may be added to the conductive medium, forming a treatment gel, to further increase effectiveness. The transducers are activated for a time frame between 1 minute and 1 hour, depending on the patient's conditions and needs. The patient may return for additional treatments periodically to improve or enhance the treatment and may be used as a preventative measure. The treatment can achieve better results with initial removal of cauculus. The method presented has great advantages over the prior art as it promotes the treatment of the disease without invasion of the gingival tissues.

The more important features of the invention have thus been outlined in order that the more detailed description that follows may be better understood and in order that the present contribution to the art may better be appreciated. Additional features of the invention will be described hereinafter and will form the subject matter of the claims that follow.

Many objects of this invention will appear from the following description and appended claims, reference being made to the accompanying drawings forming a part of this specification wherein like reference characters designate corresponding parts in the several views.

Before explaining at least one embodiment of the invention in detail, it is to be understood that the invention is not limited in its application to the details of construction and the arrangements of the components set forth in the following description or illustrated in the drawings. The invention is capable of other embodiments and of being practiced and carried out in various ways. Also it is to be understood that the phraseology and terminology employed herein are for the purpose of description and should not be regarded as limiting.

As such, those skilled in the art will appreciate that the conception, upon which this disclosure is based, may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

### BRIEF DESCRIPTION OF THE DRAWINGS

FIG. 1 is a plan view of a healthy tooth.

FIG. 2 is the tooth of FIG. 1, having periodontal disease.

FIG. 3 is the tooth of FIG. 2, undergoing scaling to remove calculus.

FIG. 4 is the tooth of FIG. 3, after scaling.

FIG. 5 is the tooth of FIG. 4, undergoing curettage.

FIG. 6 is the tooth of FIG. 5, after curettage.

FIG. 7 is the tooth of FIG. 6, after initial healing.

FIG. 8 is the tooth of FIG. 7, undergoing additional curettage.

FIG. 9 is the tooth of FIG. 8, after additional curettage.

FIG. 10 is the tooth of FIG. 9, after additional healing.

FIG. 11 is a depiction of an ultrasonic device setup capable of use in the present method.

FIG. 12 is a perspective view of an ultrasonic transducer and metal fork, used in the system of FIG. 11.

FIG. 13 is a depiction of an ultrasonic transducer with cover, metal fork and tray on the metal fork, for use in the system of FIG. 11.

FIG. 14 is a depiction of a patient undergoing treatment according to the method of the present invention.

FIG. 15 is a plan view, in partial section, of a tooth undergoing treatment according to the method of the present invention.

### DETAILED DESCRIPTION OF THE PREFERRED EMBODIMENT

With reference now to the drawings, the preferred embodiment of the treatment method is herein described. It should be noted that the articles “a”, “an”, and “the”, as used in this specification, include plural referents unless the content clearly dictates otherwise.

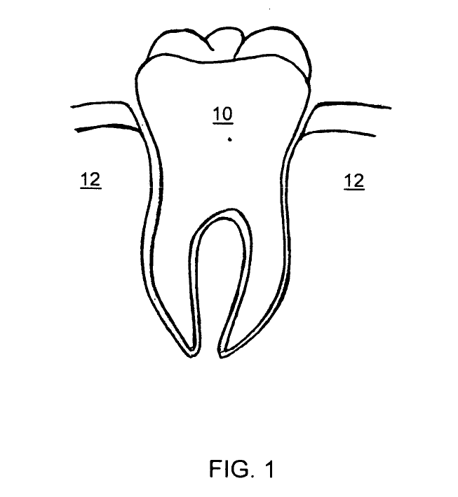

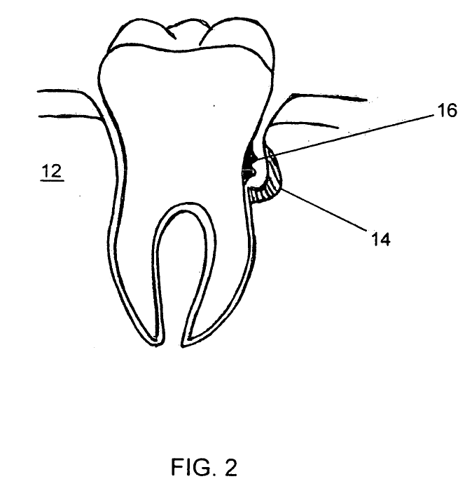

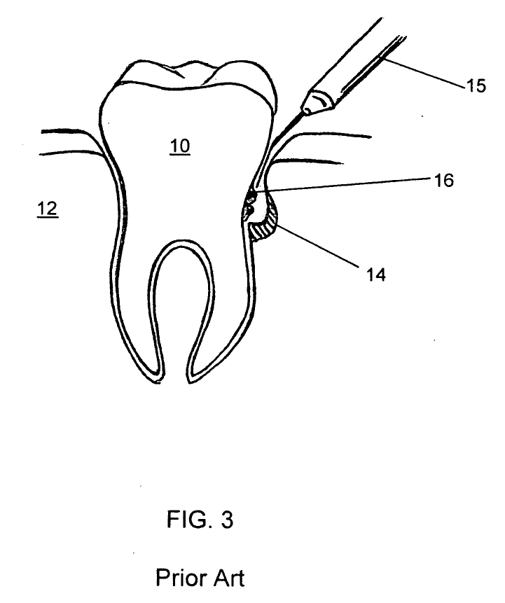

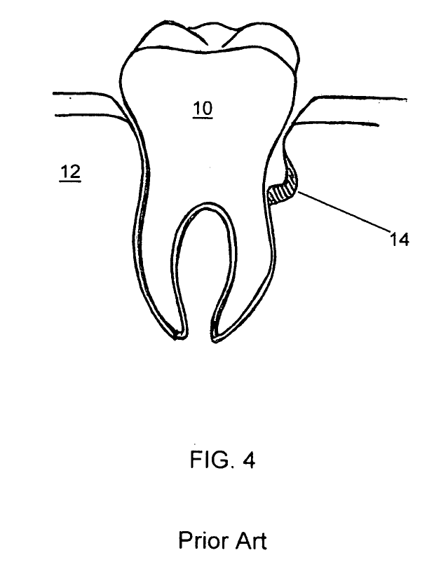

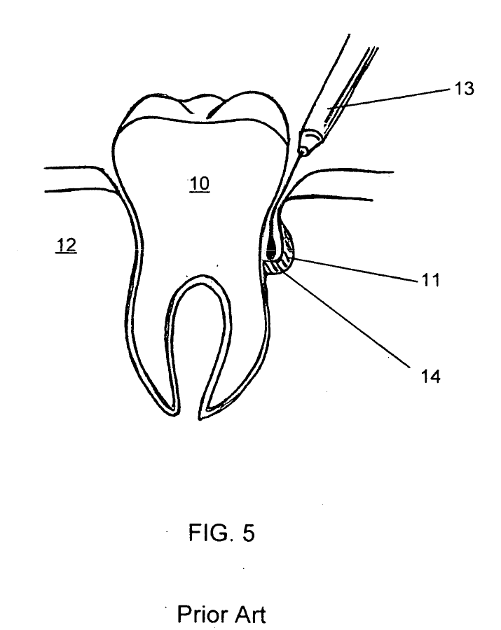

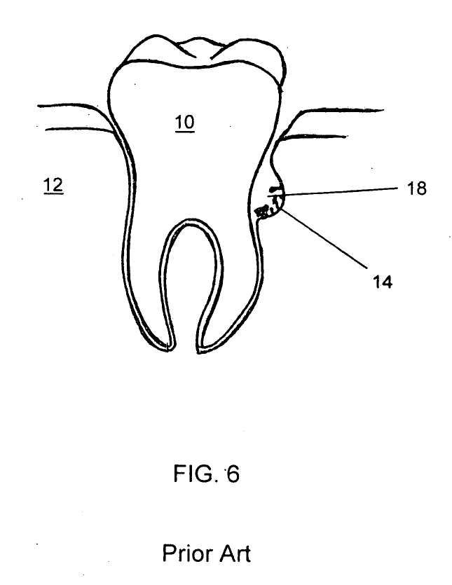

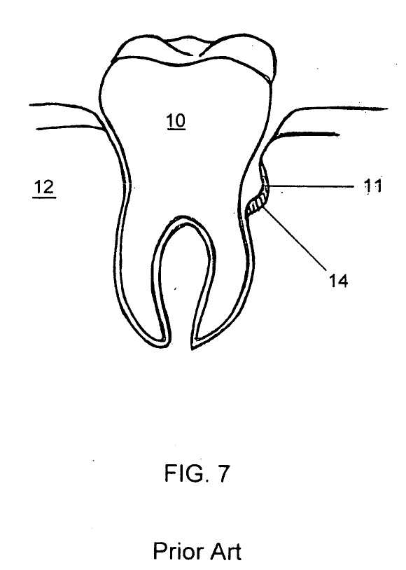

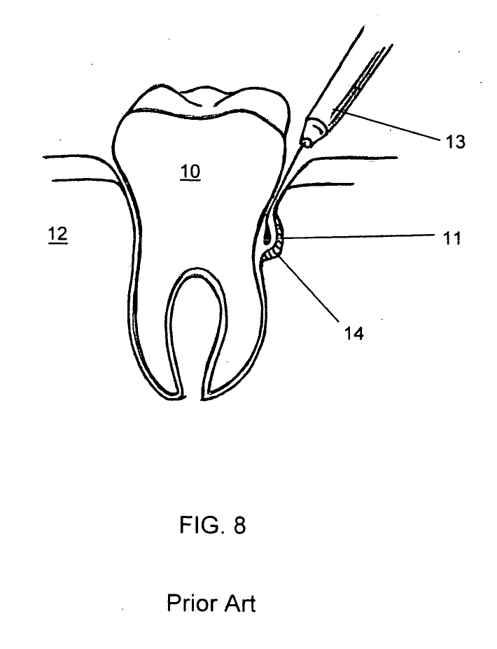

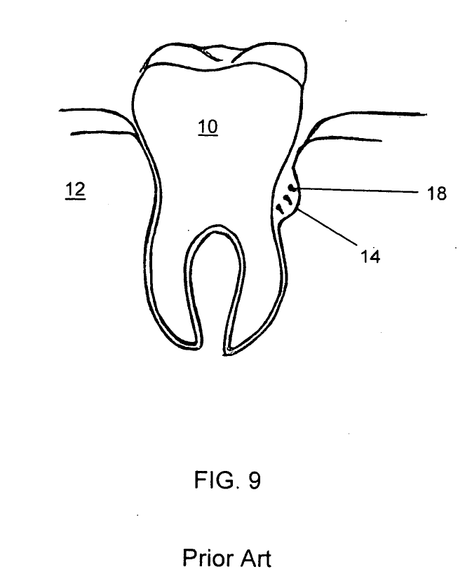

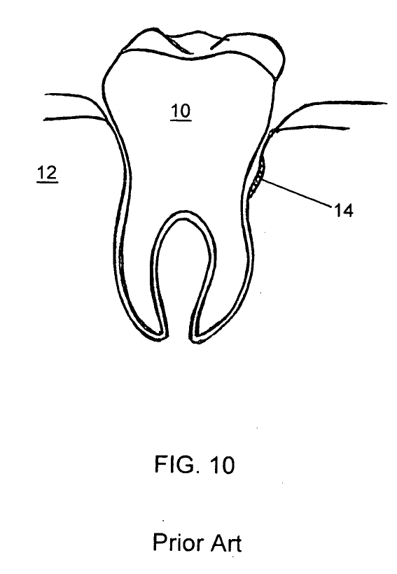

With reference to FIG. 2, a tooth 10 with advanced periodontal disease is shown, as compared to the healthy tooth of FIG. 1. It should be noted that the tooth 10, is surrounded by deep periodontal pockets 14 in the gingiva 12 and calculus 16. As shown in FIGS. 3-6 in the prior art, calculus 16 is first removed with a scaler 15. After scaling, there could be a choice for either injection of anti-bacterial medicine into the pocket or curettage. The injection of anti-microbial medicine into a periodontal pocket is not widely used in late stage treatment. Curretage is a popular method in daily practice. In curettage treatment, a curettage tool 13 is inserted in the periodontal pocket 14, removing diseased tissue 111 and causing profuse bleeding 18. The bleeding triggers the body's healing response and the periodontal tissue heals in a somewhat better condition that what it was before FIG. 7. At this point, curettage may be repeated on arguably healthy tissue to further improve the patient's condition, shown in FIGS. 8-10.

The method of the present invention for treatment of periodontal disease utilizes following components: 1) an electronic control unit to control electronic signal to ultrasonic transducers; 2) ultrasonic transducers along with metal forks; 3) treatment trays designed to fit over the metal forks and cover at least a partial arch in a patient; and 4) treatment gel.

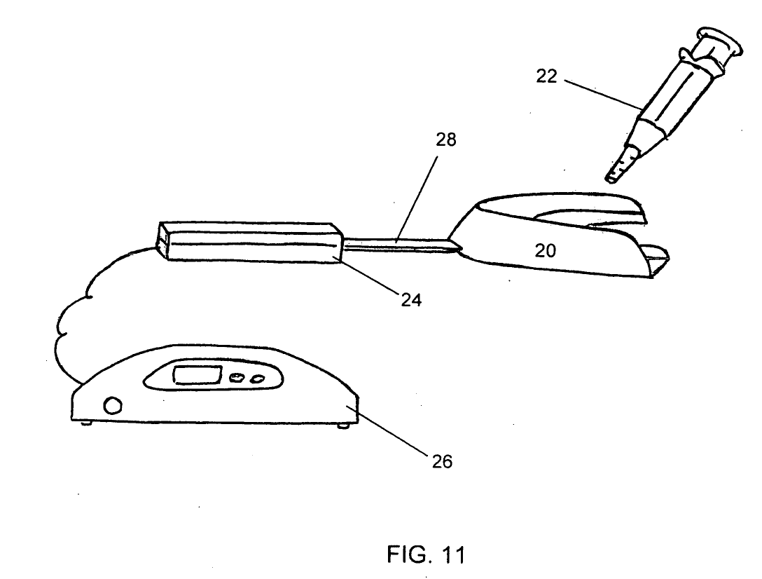

Devices suitable for this method are disclosed in the Parent application, Ser. No. 11/961,557, which has already been incorporated by reference. This application will describe he preferred embodiment of the equipment (corresponding to the devices shown in FIGS. 800, 1000, and 1100 of the Parent Application), though any device depicted in the Parent Application will suffice. FIG. 11 illustrates the entire setup of treatment system, utilizing a dual-tray treatment paradigm, where 20 is an electronic control unit with an electronic display and adjustment controls 22. The control unit is electrically powered through cord 21. The control unit has a failsafe switch 24, connected by cord 23, which is given to the patient so that the patient may stop the procedure at any time. Conduction cord 25 then is connected to the transducers 26, 27 on tines 28, 29 of forks 30, 31. Conduction cord 25 contains at least two lines for each fork used. Treatment trays 32 are added to on the forks 30, 31 prior to insertion in the patient's mouth. The function of the trays is to allow each metal fork to closely contact the teeth and gingival surface. In so doing, ultrasonic energy is efficiently conducted to the treatment surface. Forks 30, 31 should be made of a material that resists oxidation and transmits ultrasonic energy well—such as stainless steel. The trays also hold treatment gels proximate the treatment surface, if the gels are needed.

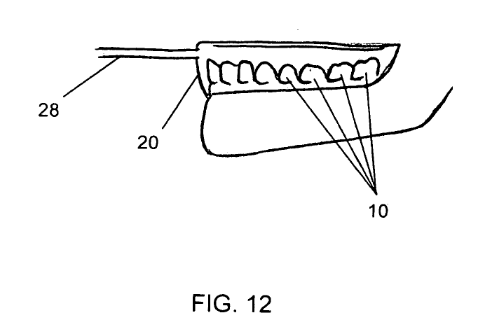

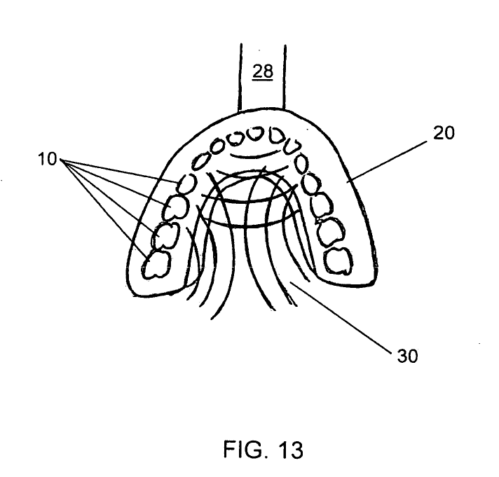

An individual fork is depicted in FIG. 12. Fork tine 33 supports fork 34 and serves as a mount for transducer 35. As can be seen in the figures, the fork 34 has a vertical (orthogonal) orientation with respect to the tine 33. This is merely a preference of design as the fork 34 could be horizontal (parallel) to the tine 33 as well and the method will still function. All that is required of the tine it that it support a tray and be able to distribute ultrasonic waves from the transducer 35 to the patient's oral cavity. Transducer 35 is connected to power lines 37, 38 (and thus the power cord and control unit) through a quick-connect, autoclavable connector 36. For treatment, a tray 39 (FIG. 13) is positioned on the fork 40. The tray must be sufficient to allow fork placement with some degree of comfort and hygiene. If a treatment gel is used, or if the treatment method is using the patient's own saliva, the tray 39 contains the gel. As before, the fork 40 branches from the tine 41, upon which the transducer 42 is mounted. The transducer 42 is connected to the control unit with an autoclavable connector 43 and for both aesthetics and protection from the elements, it is ideally covered with some form of plastic covering.

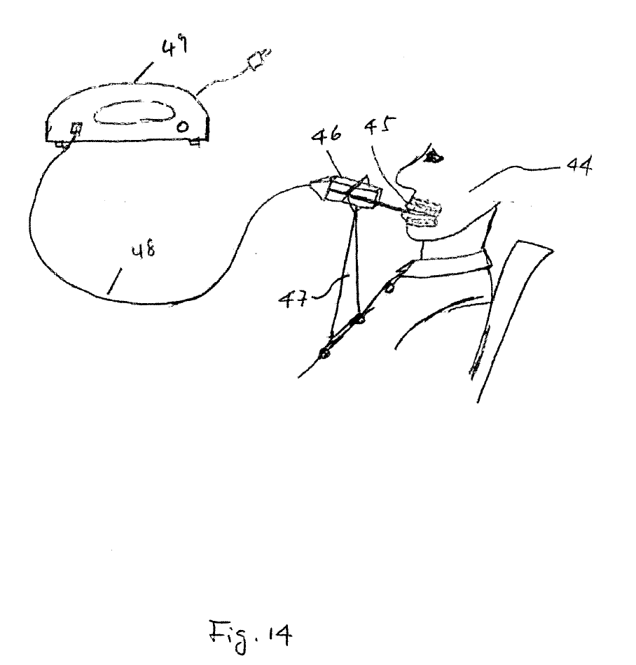

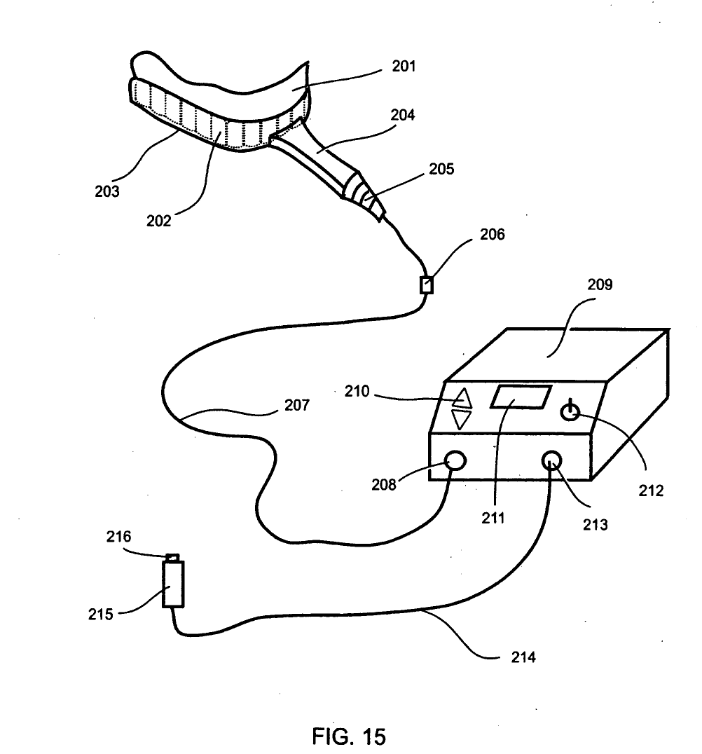

In use, FIG. 14, a patient 44 sits in a chair and has the fork (or as depicted a double fork 45) with associated tray(s) positioned on the patient's dental arch(es), making sure of good contact and coverage of the gingival margin. Prior to placement, a gel should be applied to the tray and/or the gingival margin to conduct the ultrasonic waves and provide medicine for additional treatment. The fork assembly is supported by a frame 47 which is in turn supported on the patient's chest. This support provides greater comfort for the patient as the weight of the fork 45 and associated transducers 46 are then not cantilevrally supported by the patient's teeth. Transducers 46 are connected to the control unit 49 through power cord 48. The control unit 49 then sends power to the transducers 46 according to the treatment regimen dictated by the dentist/clinician. During treatment (FIG. 15), tooth 50 and gingiva 51 are covered with a tray containing treatment gel 54. Ultrasonic waves 55 are generated by the transducer and transmitted through the fork into the tray. The waves 55 stimulate the gingiva 51 to heal the periodontal pocket 52. The gel 53 also invades the pocket 52 and the gingival margin 53 to better transmit the ultrasonic waves 55 and, if including a medicament, delivering medicine to the afflicted areas.

Ideal frequency ranges for the method are 20 to 50 kHz, inclusively. The control unit may direct a sweeping frequency over the course of the treatment. Treatment times may vary depending upon the case. Preventative treatment may take place from a minute up to 60 minutes, depending on patient conditions. Additional treatment sessions may be needed, varying actual treatment times, depending upon the needs of the patient and the judgment of the practitioner. Gel medicaments may include known and future discovered pharmaceuticals, including anti-microbial and anti-viral compounds, and nutraceuticals. Such medicaments could include chorhexidine gluconate.

Although the present invention has been described with reference to preferred embodiments, numerous modifications and variations can be made and still the result will come within the scope of the invention. No limitation with respect to the specific embodiments disclosed herein is intended or should be inferred.

What is claimed is:

1. A method for treating periodontal disease comprising the steps of:
a. placing a dental tray over at least a partial dental arch of a patient to be treated, said tray being mounted upon a metal fork which is in turn attached to at least one ultrasonic transducer and capable of transmitting ultrasonic waves; and
b. activating the at least one ultrasonic transducer and allowing ultrasonic waves to travel through the fork and stimulate gingival tissue, an electronic control consol connected to the at least one ultrasonic transducer regulating ultrasonic frequency and treatment time;
wherein the ultrasonic waves promote the healing of diseased gingival tissues without mechanical invasion of said tissues.

2. The method of claim 1, further comprising the step of filling the dental tray with a ultrasonic conductive gel prior to activation of the ultrasonic transducer.

3. The method of claim 2, the gel being a patient's own saliva, filling the tray after the tray is placed over the at least partial dental arch.

4. The method of claim 3, the method being repeated at least one more time on the patient at a later time to further promote healing.

5. The method of claim 2, the gel being added to the tray prior to placing the tray over the at least partial dental arch.

6. The method of claim 5, the gel containing medicaments.

7. The method of claim 6, the medicaments being at least one selected form the set of medicaments consisting of: antibiotic, anti-microbial, and nutraceutical medicaments.

8. The method of claim 7, the method being repeated at least one more time on the patient at a later time to further promote healing.

9. The method of claim 1, further comprising a step of applying a treatment gel to the gingival margin before the tray is positioned.

10. The method of claim 1, the ultrasonic waves have a frequency between 20 and 50 kHz, inclusively.

11. The method of claim 1, the step of placing a tray over at least a partial dental arch being accomplished by placing trays over both a lower and an upper dental arch and treatment of the same is accomplished simultaneously.

12. The method of claim 1, further comprising the step of giving the patient an override switch capable of stopping the treatment on the patient's initiative.

13. The method of claim 1, further comprising the initial step of removing calculus from at least one afflicted tooth.

14. The method of claim 13, further comprising the step of filling the dental tray with an ultrasonic conductive gel prior to activation of the ultrasonic transducer.

15. The method of claim 14, the gel being a patient's own saliva, filling the tray after the tray is placed over the at least partial dental arch.

16. The method of claim 15, the method being repeated at least one more time on the patient at a later time to further promote healing.

17. The method of claim 14, the gel being added to the tray prior to placing the tray over the at least partial dental arch.

18. The method of claim 17, the gel containing medicaments.

19. The method of claim 18, the medicaments being at least one selected form the set of medicaments consisting of: antibiotic, anti-microbial, and nutraceutical medicaments.

20. The method of claim 19, the method being repeated at least one more time on the patient at a later time to further promote healing.

21. The method of claim 13, the ultrasonic waves have a frequency between 20 and 50 kHz, inclusively.

22. The method of claim 13, further comprising a step of applying a treatment gel to the gingival margin before the tray is positioned.

23. The method of claim 13, the step of placing a tray over at least a partial dental arch being accomplished by placing trays over both a lower and an upper dental arch and treatment of the same is accomplished simultaneously.

24. The method of claim 13, further comprising the step of giving the patient an override switch capable of stopping the treatment on the patient's initiative.

25. A method for treating periodontal disease comprising the steps of:
a. placing a dental tray, attached to an ultrasonic transducer and capable of transmitting ultrasonic waves, over at least a partial dental arch of a patient to be treated; and
b. activating the ultrasonic transducer and allowing ultrasonic waves to stimulate gingival tissue;
wherein the ultrasonic waves promote the healing of gingival tissue.
